(19) United States
(12) Patent Application Publication
(10) Pub. No.: US 2026/0105401 A1
(43) Pub. Date: Apr. 16, 2026

(54) SCORE SHIFT SEGMENT MINING TOOL FOR DYNAMIC DATA ANALYSIS AND PERFORMANCE MONITORING

(71) Applicant: FAIR ISAAC CORPORATION, Minneapolis, MN (US)

(72) Inventors: Liang Meng, San Rafael, CA (US); Gerald Fahner, Austin, TX (US)

(21) Appl. No.: 18/914,923

(22) Filed: Oct. 14, 2024

(51) Int. Cl. G06Q 10/0639; G06Q 30/0204

(52) U.S. Cl. CPC G06Q 10/0639; G06Q 30/0204

(57) ABSTRACT

A method for dynamic data analysis and segmentation for performance monitoring within a population, the method comprising: maintaining, by a processor, a dataset comprising score distributions and odds-to-score relationships for a population over multiple time periods; identifying, by the processor, a plurality of segments within the population based on predefined characteristics stored in a database, wherein the segments are updated in real-time based on predefined rules; executing, by the processor, a machine learning (ML) model trained to detect shifts associated with each segment by analyzing changes in the score distribution or odds-to-score relationships over the multiple time periods; and generating, by the processor, segment profiles that include statistical measures for each identified segment based on the detected shifts, wherein the statistical measures include at least a mean score, a median score, and changes in the odds-to-score relationship.

### TECHNICAL FIELD

The subject matter described herein relates to machine learning (ML) technology, specifically systems and methods for dynamic data analysis and segmentation for performance monitoring across various industries, utilizing machine learning models to detect shifts in performance metrics over time and optimize segment definitions in real-time.

### BACKGROUND

In many industries, such as healthcare and finance, tracking shifts in performance metrics over time is crucial for making informed decisions. These shifts may occur due to various factors such as economic changes, population shifts, or evolving patient needs. Traditional methods of monitoring these shifts often rely on predefined segments or static analysis, which can fail to detect nuanced or emerging trends. As a result, organizations may miss opportunities to optimize decision-making strategies, allocate resources effectively, or intervene in critical situations where shifts in performance indicate underlying risks or opportunities.

Current approaches to performance monitoring often focus on the overall population or preselected subgroups, which may not thoroughly account for shifts occurring within smaller or dynamically changing segments. This can lead to incomplete insights and a lack of adaptability in response to evolving conditions. Moreover, manual analysis and static segmentation methods can be time-consuming, error-prone, and may not capture the full range of shifts that could be impacting the performance of various segments.

There is a need for more advanced systems that can automatically and dynamically identify the most significant shifts in performance metrics across multiple time periods. Such systems would enable organizations to not only detect and monitor these shifts but also provide the flexibility to analyze performance across different industries, such as healthcare and finance, without being constrained by traditional, static methods of segmentation. This capability would allow for more comprehensive segment profiling and provide deeper insights into the segments experiencing the most substantial changes in performance.

### SUMMARY

Methods, systems, and computer program products are provided for dynamic data analysis and segmentation for performance monitoring within a population, where a computer-implemented method includes maintaining by a processor a dataset comprising score distributions and odds-to-score relationships for a population over multiple time periods, identifying by the processor a plurality of segments within the population based on predefined characteristics stored in a database, wherein the segments are updated in real-time based on predefined rules, executing by the processor a machine learning (ML) model trained to detect shifts associated with each segment by analyzing changes in the score distribution or odds-to-score relationships over multiple time periods, and generating by the processor segment profiles that include statistical measures for each identified segment based on the detected shifts, wherein the statistical measures include at least a mean score, a median score, and changes in the odds-to-score relationship.

In some variations, the ML model is trained by applying a dimension reduction technique to select relevant features and to analyze shifts in score distribution and odds-to-score relationships over multiple time periods.

In some variations, the method further comprises applying by the processor a threshold-based filtering process to exclude segments that do not meet minimum criteria, the criteria including at least segment size, percentage of a total population, raw count of sample records, score range, and number of unique score values.

In some variations, defining the segments comprises using a consistent segment definition across time periods to determine the composition of the segment at each time and track shifts in the composition of the segment, wherein the composition of segments is dynamically adjusted based on predefined rules stored in a rule engine.

In some variations, defining the segments comprises using a consistent population definition across time periods to identify a group of individuals at a user-specified point in time and track shifts in performance metrics for the segment across multiple time periods.

In some variations, the method further comprises optimizing the execution of the ML model by utilizing parallel processing across multiple processing units to enhance efficiency in high-dimensional parameter spaces.

In some variations, the ML model includes executing by the processor a subroutine to quantify a vertical shift of an odds-to-score fitted line and changes in its slope by calculating a regression model for the odds-to-score relationship over specified time periods.

In another aspect, a computer program product is provided, wherein the computer program product includes a non-transient machine-readable medium storing instructions that, when executed by at least one programmable processor, cause the at least one programmable processor to perform operations comprising maintaining by the processor a dataset comprising score distributions and odds-to-score relationships for a population over multiple time periods, identifying by the processor a plurality of segments within the population based on predefined characteristics stored in a database, wherein the segments are updated in real-time based on predefined rules, executing by the processor an ML model trained to detect shifts associated with each segment by analyzing changes in the score distribution or odds-to-score relationships over multiple time periods, and generating by the processor segment profiles that include statistical measures for each identified segment based on the detected shifts, wherein the statistical measures include at least a mean score, a median score, and changes in the odds-to-score relationship.

In some variations, the ML model is trained by applying a dimension reduction technique to select relevant features and analyze shifts in score distribution and odds-to-score relationships over multiple time periods.

In some variations, the computer program product further comprises applying a threshold-based filtering process to exclude segments that do not meet minimum criteria, the criteria including at least segment size, percentage of a total population, raw count of sample records, score range, and number of unique score values.

In some variations, defining the segments comprises using a consistent segment definition across time periods to determine the composition of the segment at each time and track shifts in the composition of the segment, wherein the composition of segments is dynamically adjusted based on predefined rules stored in a rule engine.

In some variations, defining the segments comprises using a consistent population definition across time periods to identify a group of individuals at a user-specified point in time and track shifts in performance metrics for the segment across multiple time periods.

In some variations, the computer program product further comprises optimizing the execution of the ML model by utilizing parallel processing across multiple processing units to enhance efficiency in high-dimensional parameter spaces.

In some variations, the ML model includes executing a subroutine to quantify a vertical shift of an odds-to-score fitted line and changes in its slope by calculating a regression model for the odds-to-score relationship over specified time periods.

In another aspect, a system is provided, wherein the system includes a programmable processor and a non-transient machine-readable medium storing instructions that, when executed by the processor, cause the at least one programmable processor to perform operations comprising maintaining by the processor a dataset comprising score distributions and odds-to-score relationships for a population over multiple time periods, identifying by the processor a plurality of segments within the population based on predefined characteristics stored in a database, wherein the segments are updated in real-time based on predefined rules, executing by the processor an ML model trained to detect shifts associated with each segment by analyzing changes in the score distribution or odds-to-score relationships over multiple time periods, and generating by the processor segment profiles that include statistical measures for each identified segment based on the detected shifts, wherein the statistical measures include at least a mean score, a median score, and changes in the odds-to-score relationship.

In some variations, the ML model is trained by applying a dimension reduction technique to select relevant features and analyze shifts in score distribution and odds-to-score relationships over multiple time periods.

In some variations, the system further comprises applying a threshold-based filtering process to exclude segments that do not meet minimum criteria, the criteria including at least segment size, percentage of a total population, raw count of sample records, score range, and number of unique score values.

In some variations, defining the segments comprises using a consistent segment definition across time periods to determine the composition of the segment at each time and track shifts in the composition of the segment, wherein the composition of segments is dynamically adjusted based on predefined rules stored in a rule engine.

In some variations, defining the segments comprises using a consistent population definition across time periods to identify a group of individuals at a user-specified point in time and track shifts in performance metrics for the segment across multiple time periods.

In some variations, the system further comprises optimizing the execution of the ML model by utilizing parallel processing across multiple processing units to enhance efficiency in high-dimensional parameter spaces.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating an example of different types of segment shift, in accordance with one or more embodiments of the current subject matter.

FIG. 2 is a diagram illustrating an example of the identified segments by the segment mining tool, in accordance with one or more embodiments.

FIG. 3 is a diagram illustrating an example of the identified segments by the segment mining tool, in accordance with one or more embodiments.

FIG. 4 is a diagram illustrating a flow chart of a process for dynamic data analysis and segmentation for performance monitoring within a population, in accordance with one or more embodiments of the current subject matter.

FIG. 5 depicts a block diagram illustrating a computing system consistent with implementations of the current subject matter.

When practical, like labels are used to refer to same or similar items in the drawings.

### DETAILED DESCRIPTION

The details of one or more variations of the subject matter described herein are set forth in the accompanying drawings.

As discussed herein elsewhere, machine learning models, particularly those capable of dynamic data analysis, have been widely adopted across various industries to address complex challenges. From identifying emerging health risks in patient populations to detecting financial fraud and credit risks, these models have enabled organizations to make more informed, data-driven decisions. Industries such as healthcare and finance increasingly rely on these advanced techniques to uncover hidden patterns and trends, empowering decision-makers to respond more swiftly and accurately to shifts in their operating environments. As the need for more granular and adaptive analysis grows, the importance of automated tools capable of detecting segment-specific shifts in performance metrics over time has become paramount. Organizations are seeking solutions that not only track these shifts but also provide real-time insights, thereby improving operational efficiency and competitive positioning.

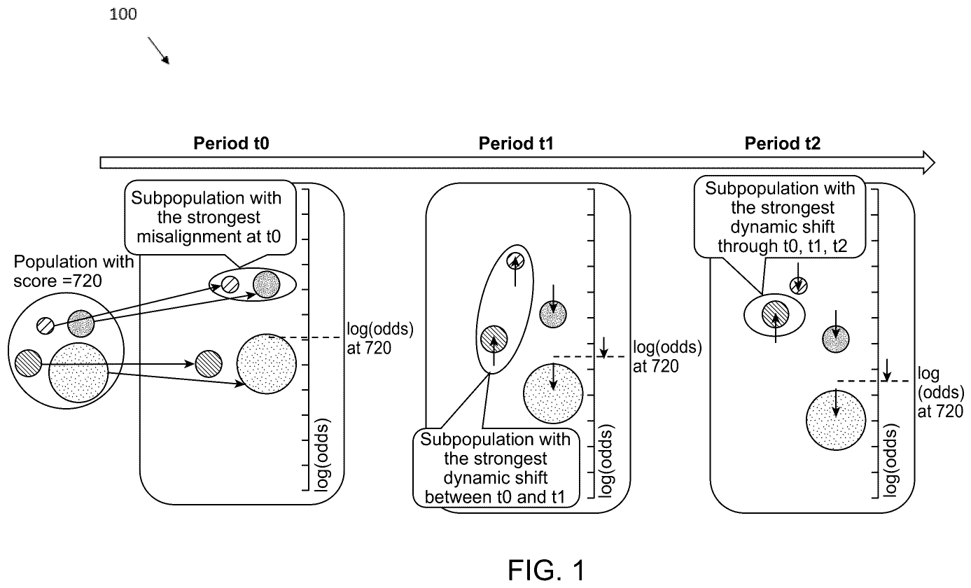

FIG. 1 is a diagram illustrating an example of different types of segment shift, in accordance with one or more embodiments of the current subject matter. As shown in FIG. 1, segment shifts can occur both as static shifts at a single period and as dynamic shifts across multiple time periods. A static shift refers to the dissimilarity of a subpopulation to the overall population in terms of the score-to-odds relationship within a single time period. For example, a particular subpopulation may exhibit a different score-to-odds pattern compared to the broader population at a given point in time, signaling a deviation that might indicate underlying issues or opportunities specific to that group. Additionally or alternatively, dynamic shifts capture dissimilarities in the temporal movement of a subpopulation relative to the overall population across multiple time periods. These shifts consider both the evolution of the score-to-odds relationship and changes in score distribution over time. Dynamic shifts can provide insights into how certain segments of the population deviate from overall trends, allowing organizations to track changes that may be missed when only focusing on static shifts. For example, a subpopulation may initially align with the overall population but gradually diverge due to external factors such as macro-economic changes or demographic shifts.

In some embodiments, static shifts can be defined by analyzing the deviation of a subpopulation's score-to-odds relationship compared to the overall population. This method of analysis allows for capturing immediate discrepancies within a single time period, highlighting instances where a subpopulation may behave differently in terms of predicted versus actual risk. For example, the deviation in predicted risk from its actual risk can be quantified using the score-to-odds relationship calibrated on the overall population. In some embodiments, the deviation may be expressed in various scales. For example, in the log (odds) scale, this deviation can be calculated as:

$${\vert log {( odds )}^{s u b} - \vert}_{totmodel} \vert$$

which allows for a more granular analysis of the shifts in odds. Similarly, in the probability scale, the deviation can be expressed as:

$${\vert {P}^{s u b} - {\hat{P}}^{s u b} \vert}_{totmodel} \vert$$

These scales provide different perspectives on the severity of the shift in risk perception within the subpopulation.

In some embodiments, differences in score points-to-double-odds (PDO) may also be used to analyze these static shifts. The deviation in the PDO scale can be calculated as:

$${{\vert PD {O}^{s u b} \vert}_{submodel} - {PDO}^{tot} \vert}_{totmodel} \vert$$

which offers a normalized metric for comparing the risk differentiation power between subpopulations and the total population. By using these scales and metrics, organizations can detect and respond to emerging trends or anomalies within specific segments.

In some embodiments, a dynamic shift between two time periods (t_0 and t_1) may be defined as the shift of a subpopulation relative to the shift of the overall population. This shift may be measured by various methods, such as by analyzing changes in the score-to-odds relationship, score distribution, or population odds between t_0 and t_1.

For example, when using the score-to-odds relationship, the “additional” deviation of predicted risk from actual risk at t_1 can be measured using the score-to-odds relationship calibrated at t_0. In some embodiments, this deviation may be expressed in the log (odds) scale as:

$${{{{\vert ( {log ( odds )}^{{t}_{1}} - \vert}_{{t}_{0} model} )}^{sub} - ( {log ( odds )}^{{t}_{1}} - \vert}_{{t}_{0} model} )}^{tot} \vert$$

This additional deviation allows for the detection of changes in predicted risk for subpopulations that differ from the overall population shift.

In another embodiment, the “additional” difference in score points-to-double-odds (PDO) between t_0 and t_1 can be used to analyze these shifts. In the PDO scale, the shift may be expressed as:

$$\vert {( {PDO}^{{t}_{1}} {\vert}_{{t}_{1} model} - {PDO}^{{t}_{0}} {\vert}_{{t}_{0} m o d e l} )}^{s u b} - {( {PDO}^{{t}_{1}} {\vert}_{{t}_{1} model} - {PDO}^{{t}_{0}} {\vert}_{{t}_{0} m o d e l} )}^{tot} \vert$$

Dynamic shifts may also be captured by changes in score distribution. For instance, an “additional” difference in score summary statistics such as the mean or median can be expressed as:

$$\vert {( {\overline{S}}^{{t}_{1}} - {\overline{S}}^{{t}_{0}} )}^{s u b} - {( {\overline{S}}^{{t}_{1}} - {\overline{S}}^{{t}_{0}} )}^{tot} \vert$$

In some embodiments, the tool can analyze population proportions at specific score cutoffs. For example, the “additional” difference in the proportion of the population with a score less than or equal to a key cutoff can be expressed as:

$$\vert {( {P ( S \leq cutoff )}^{{t}_{1}} - {P ( S \leq cutoff )}^{{t}_{0}} )}^{sub} - {( {P ( S \leq cutoff )}^{{t}_{1}} - {P ( S \leq cutoff )}^{{t}_{0}} )}^{tot} \vert$$

Finally, changes in population odds can be captured in the log (odds) scale to measure deviations over time:

$$\vert ( {log ( odds )}^{{t}_{1}} - {( {log ( odds )}^{{t}_{0}} )}^{s u b} - ( {log ( odds )}^{{t}_{1}} - {( {log ( odds )}^{{t}_{0}} )}^{tot} \vert$$

By utilizing these methods, the tool can provide a comprehensive view of how subpopulations are evolving over time in comparison to the reference baseline population, identifying patterns that may signal important shifts in performance metrics.

In some embodiments, a dynamic shift across multiple time periods (t_0, t_1, t_2, . . . , t_n) may be defined as the accumulated period-over-period shift of a subpopulation relative to the accumulated shift of the overall population. This can be measured using various methods, such as by analyzing the score-to-odds relationship, score distribution, or population proportions across consecutive time periods. Detecting dynamic shifts across multiple time periods enables organizations to take proactive steps, such as recalibrating machine learning models or adjusting decision-making processes. For example, in the finance industry, significant cumulative shifts in risk metrics might prompt an institution to revise credit scoring thresholds or update lending criteria. Similarly, in healthcare, identifying a dynamic shift in patient health metrics over time could lead to early interventions or adjustments in treatment protocols.

For example, in measuring the score-to-odds relationship, the “additional” deviation of predicted risk from actual risk can be cumulated for each pair of consecutive time periods (t_0, t_1), (t_1, t_2), . . . , (t_(n−1), t_n). In the log (odds) scale, this cumulative deviation may be expressed as:

$${\sum }_{i = 1}^{n} \vert {( {log ( odds )}^{{t}_{i}} - {\vert}_{{t}_{i - 1} m o d e l} )}^{s u b} - {( {log ( odds )}^{{t}_{i}} - {\vert}_{{t}_{i - 1} m o d e l} )}^{tot} \vert$$

Similarly, the “additional” difference of score points-to-double-odds (PDO) between consecutive time periods can be cumulated for a more comprehensive understanding of shifts. In the PDO scale, this cumulative difference may be expressed as:

$${\sum }_{i = 1}^{n} \vert {( {PDO}^{{t}_{1}} {\vert}_{{t}_{1} model} - {PDO}^{{t}_{i - 1}} {\vert}_{{t}_{i - 1} m o d e l} )}^{s u b} - {( {PDO}^{{t}_{1}} {\vert}_{{t}_{1} model} - {PDO}^{{t}_{i - 1}} {\vert}_{{t}_{i - 1} m o d e l} )}^{tot} \vert$$

In some embodiments, the tool may analyze shifts in score distribution, cumulating the “additional” difference in score summary statistics, such as the mean, for each pair of consecutive time periods. This may be expressed as:

$${\sum }_{i = 1}^{n} \vert {( {\overline{S}}^{{t}_{i}} - {\overline{S}}^{{t}_{i - 1}} )}^{s u b} - {( {\overline{S}}^{{t}_{i}} - {\overline{S}}^{{t}_{i - 1}} )}^{tot} \vert$$

The cumulative “additional” difference of the population proportion whose score is less than or equal to (or greater than) a key cutoff can also be defined for each pair of consecutive time periods. This may be expressed as:

Left-side proportion:

$${\sum }_{i = 1}^{n} \vert {( {P ( S \leq cutoff )}^{{t}_{i}} - {P ( S \leq cutoff )}^{{t}_{i - 1}} )}^{sub} - {( {P ( S \leq cutoff )}^{{t}_{i}} - {P ( S \leq cutoff )}^{{t}_{i - 1}} )}^{tot} \vert .$$

To track these shifts effectively, the score shift segment mining tool can determine subpopulations in multiple ways. In some embodiments, a consistent segment definition across time approach may be utilized. This approach applies the same segment definition at each time period to identify a series of subpopulations. These segments may consist of different individuals in each period, but the criteria for segment membership remain the same over time. This method may be useful in industries like loan origination, where each time period might involve new applicants that fit the defined segment criteria. In industries beyond healthcare and finance, such as retail, manufacturing, or transportation, consistent segment definitions may help track shifts in consumer preferences, product demand, or operational performance. For instance, in retail, tracking purchasing behavior within defined customer segments over time could inform targeted marketing strategies, while in manufacturing, monitoring defect rates in specific product lines may help optimize quality control efforts. This method may be useful in the healthcare industry, for example, when tracking patients with high blood pressure across different time periods. Each period may involve new patients diagnosed with high blood pressure, but the defined segment criteria (such as blood pressure above a certain threshold) remain unchanged, allowing for consistent monitoring of trends in this condition across time. In some embodiments, the system may utilize a rules engine to dynamically adjust the segment definitions across time periods. The rules engine may store predefined criteria based on demographic, behavioral, or statistical attributes. These rules may adapt the segments as new data is received or as certain thresholds are met, ensuring that the defined segments remain relevant to the current population characteristics. Adjustments to segments may occur when the underlying population shifts or when performance metrics, such as average score or odds, deviate significantly from historical trends.

In some embodiments, a consistent population definition across time approach may be utilized. This approach defines a subpopulation and/or composition at a specific point in time and tracks the same group of individuals across multiple time periods. While the population remains fixed, shifts in performance metrics for this defined group are measured over time, allowing for continuous monitoring of the same subpopulation. This method may be useful in industries like account management, where understanding how a stable group of customers evolves over time is critical for assessing risk, behavior, or engagement. This method is particularly useful in healthcare, for example, when managing patients with chronic conditions like diabetes. Tracking the same group of patients over time provides insights into how their health metrics evolve, enabling continuous assessment of treatment effectiveness and disease progression.

### Objective Function Definition

In some embodiments, the score shift segment mining tool is designed to pursue various types of score shifts, each of which can be measured using different methodologies. The tool provides flexible measurement options to quantify score dynamics in several scenarios, enabling more comprehensive analysis. For example, the tool may measure score misalignment at a single time period, where it identifies discrepancies between the score distributions of subpopulations and/or compositions and the overall population within a single snapshot of time. This approach is particularly useful for understanding immediate or isolated deviations that could indicate emerging trends or anomalies in the data. A shift in score distribution refers to a measurable change in score metrics such as mean, median, or percentile values between time periods. These shifts could be identified based on deviations in the score-to-odds relationship or in the statistical properties of the score distributions. In some embodiments, shifts may capture both short-term fluctuations and long-term trends, providing a comprehensive view of how subpopulations' behaviors or risks evolve over time. In some embodiments, the system may employ a dimension reduction technique during model training to improve the selection of relevant features from high-dimensional data. This technique reduces the complexity of the data by eliminating redundant or non-informative features, allowing the machine learning model to focus on key variables that contribute to shifts in performance metrics. Dimension reduction may include methods such as Principal Component Analysis (PCA), Singular Value Decomposition (SVD), or other statistical techniques.

In some embodiments, the tool can measure short-term score shifts between two time periods. This type of analysis focuses on capturing the change in performance metrics over a relatively brief interval, such as a quarter or a year, to detect any rapid shifts in behavior or outcomes for specific subpopulations. This may be valuable in scenarios where early detection of shifts can prompt timely interventions or adjustments in strategy. The tool may also measure long-term score shifts across multiple time periods. In some embodiments, this involves tracking the evolution of score distributions and performance metrics over extended periods, potentially years, to identify broader trends and patterns. Such long-term analysis can reveal more gradual changes in population behavior, allowing organizations to make informed decisions based on cumulative data. In some embodiments, the system may quantify vertical shifts in the odds-to-score fitted line by applying a regression model. This model calculates the slope and intercept of the odds-to-score relationship over the specified time periods. Vertical shifts indicate deviations in the risk predictions, and changes in slope reflect adjustments in the score-to-odds calibration over time. The regression model may be applied to identify significant alterations in the score distribution, providing insights into population behavior and risk levels.

Additionally, the tool provides options to account for period-over-period shift direction. In some embodiments, since the default measurements may only capture absolute values (i.e., the magnitude of the shift without direction), the tool can offer measurement forms that explicitly track whether a score shift is positive or negative. This capability aids in providing a more nuanced understanding of whether the performance metrics are improving or deteriorating over time.

To facilitate this, the tool may provide three specific direction options for each shift measurement:
Negative shift: In some embodiments, this may be calculated using a function like min(*,0), which captures only downward (negative) shifts, excluding upward changes.
Positive shift: In some embodiments, this option can be calculated using a function like max(*,0), allowing users to focus exclusively on upward (positive) shifts in score dynamics.
Any shift: In some embodiments, users may prefer to capture both positive and negative shifts, which can be achieved using an absolute value function, denoted as |*|, to account for the total magnitude of the change regardless of its direction.

By providing these flexible measurement options, the score shift segment mining tool enables users to adapt the analysis to their specific needs, whether they are tracking isolated score deviations, monitoring short-term shifts, or analyzing long-term trends. Furthermore, the inclusion of directional shift analysis offers a more detailed understanding of how scores evolve over time, allowing for more targeted actions and decision-making based on the detected patterns. In the healthcare industry, these flexible measurement options can be applied to monitor patient health metrics over time. For example, tracking isolated score deviations can help detect sudden changes in a patient's condition, such as a significant drop in blood oxygen levels, prompting immediate intervention. Short-term score shifts may track the effectiveness of a treatment, such as monitoring blood glucose levels in diabetic patients after starting a new medication. Long-term score shifts, like analyzing cholesterol or blood pressure trends over several years, can reveal gradual improvements or deterioration, aiding in long-term care planning. Directional shift analysis provides further insights into whether patient health metrics are improving or worsening, enabling providers to respond proactively. These tools enable healthcare organizations to make more informed, data-driven decisions, offering personalized and timely care based on evolving health trends.

### Segment Search

In some embodiments, the tool conducts segment search by formulating it as an optimization problem, where the measurement of the score shift serves as the objective function. The tool optimizes this function by leveraging Bayesian optimization, which efficiently explores all possible segment definitions. Bayesian optimization is particularly suited for handling complex and non-differentiable objective functions, as it does not require explicit gradient calculation. This flexibility allows it to accommodate the inherent complexities of segment search, where segment boundaries and score dynamics may vary widely.

The segment search process begins with a 1-dimensional (1D) search, exploring intervals within the ordinal value range of numeric segmenters, excluding nominal or categorical segmenters and special numeric values. The 1D search identifies subpopulations showing significant score shifts within specific numeric ranges. For example, in financial applications, this could involve ranges of credit scores, and in healthcare, it might be used to analyze patient health metrics. To enhance the interpretability and usability of segment boundaries, the tool applies a rounding scheme where segmenters are rounded based on their data type, such as tally, amount, or ratio. To further optimize the search, a dimension reduction scheme may be employed, limiting the exploration space to pre-specified quantiles of the rounded segmenters, ensuring that the search remains focused on the most relevant portions of the data.

In some embodiments, the tool allows the application of a half-open constraint to the 1D interval. This option restricts the segment search to specific parts of the data range by constraining the interval from one side, either left or right, allowing for more focused segment analysis. For instance, in healthcare, this could involve focusing on patients above a certain age threshold. Once the 1D segments are discovered, the tool proceeds to investigate 2-dimensional (2D) segments, adding another dimension to the analysis to uncover incremental insights. A heuristic segmenter selection process refines the 2D search scope, based on the 1D results, to identify correlations or intersections between two different segmenters that yield more significant score shifts.

The 2D search involves multiple steps: manually selecting the top N segmenters from the 1D results, calculating the similarity or overlap percentage between each pair of selected segmenters, and filtering out pairs whose overlap is either too low (less than 10%) or too high (greater than 90%). The 2D segment is represented as the intersection of two 1D intervals, forming a rectangular area in a 2D plane. This graphical representation helps visualize how the subpopulation defined by the two segmenters behaves in terms of score shifts. As with the 1D search, the half-open constraint can be applied to the 2D search, allowing further refinement of the segment boundaries. If the 2D segments exhibit significant incremental value, the tool may proceed to higher-dimensional searches, continuing the process until the incremental value diminishes.

During the segment search, the tool incorporates mechanisms to avoid trivial or insignificant segments by controlling segment size through minimum requirements. These thresholds control that only meaningful and statistically relevant segments are selected. For example, segments must cover at least 5% of the total population, include at least 1,000 sample records, span a score range of at least 100 points, and contain at least 50 unique score values. By enforcing these thresholds, the tool facilitates that the discovered segments are meaningfully large with adequate statistical evidence to provide actionable insights that are useful for decision-making in a variety of applications.

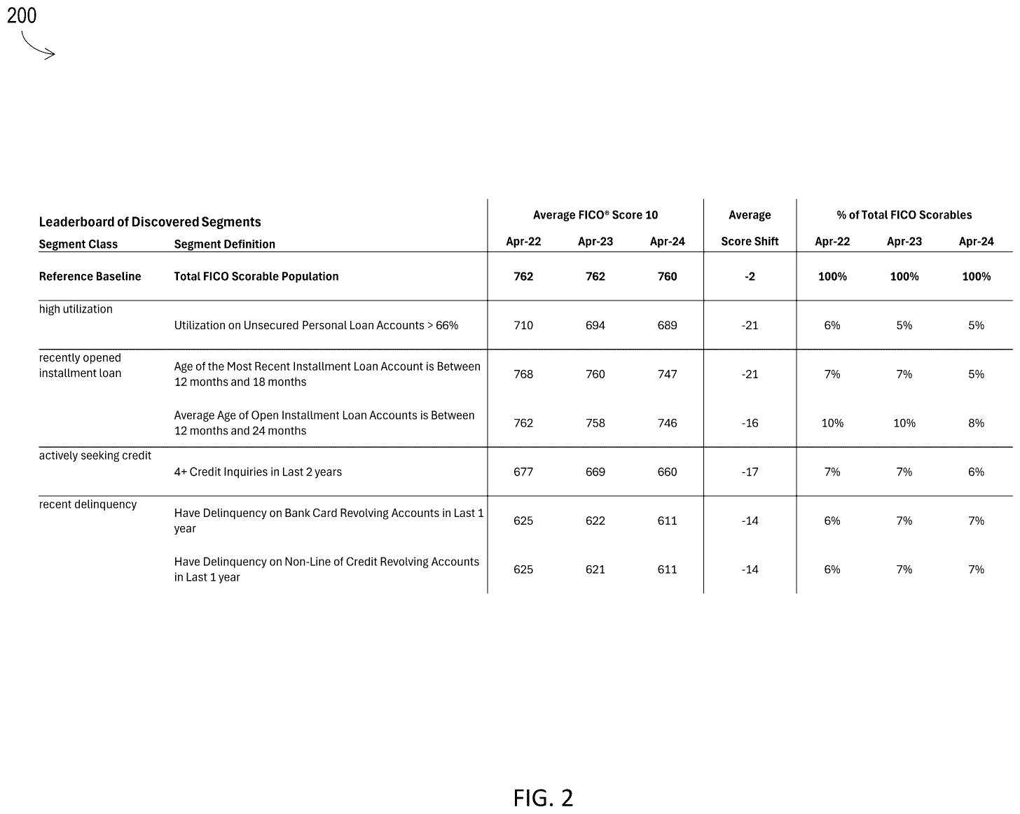

FIG. 2 is a diagram illustrating an example of the identified segments by the segment mining tool, in accordance with one or more embodiments. In this example, the considerations for searching the segment may be defined by a user, and the configurable ranges may be customizable. For example, the key considerations may include:
Focus on the shift of average score over post-pandemic years between 2022 and 2024.
Use the shift of the average credit score on the overall Canadian scorable population as the reference baseline shift.
Restrict segment size to be at least 5% of the total scorable population.
Search for segments with substantial “additional” shifts in the average credit score over the recent 3 years relative to the reference baseline shift.
Profile discovered segments with key credit metrics in five categories: payment history, amounts owed, credit length, new credit, and credit mix.

As shown in FIG. 2, from 2022 to 2024, in comparison to the modest year-over-year shift of the average credit score on the total scorable population, a set of segments are identified with much stronger year-over-year shifts (10+ score points). The leading segments can be summarized into four classes, including recent delinquency, recently opened installment loans, actively seeking credit, and high utilization. As shown in FIG. 2, In some embodiments, the reference baseline score remains relatively stable, with only a minor decrease of 2 points between 2022 and 2024. This stability is consistent with the general observation that the average score across the entire population does not fluctuate dramatically. The reference baseline serves as a useful comparison point for analyzing shifts in other more volatile segments, and in some embodiments, the modest decline in the baseline can be attributed to external factors such as macroeconomic changes that affect the overall population's creditworthiness.

In some embodiments, individuals with high utilization on unsecured personal loans experience a significant 21-point drop in score, from 710 in 2022 to 689 in 2024. This notable decrease may be linked to the fact that high utilization rates often negatively impact credit scores, as they indicate a higher level of credit risk. For example, high utilization rates suggest that individuals are heavily reliant on borrowed funds, which can be a sign of financial distress. This financial distress can be escalated in the economic environment of high interest rate after 2023, which leads to more miss payment and consequently higher score decline. The percentage of the total scorable population in this category decreases slightly, from 6% to 5%, which may indicate either improved credit management habits, such as paying down balances, or changes in credit-seeking behavior over this period.

Similarly, in some embodiments, individuals with recently opened installment loans exhibit a 21-point drop in their credit scores over the same 3-year period, decreasing from 768 in 2022 to 747 in 2024. This trend suggests that the presence of new installment loans correlates with declining credit scores, potentially due to the added financial burden or the credit risk associated with new debt obligations. The presence of recent debt burden compound with rising interest rate likely intensifies affordability issue and drives downward score shift. The percentage of the population in this segment decreases from 7% to 5%, possibly indicating that fewer people are opening new loans during this time or that tighter lending standards are in place.

In some embodiments, the average age of open installment loans segment shows a more moderate decline, with the score dropping by 16 points, from 762 in 2022 to 746 in 2024. This reduction is less severe compared to other segments, reflecting the typical aging of loan accounts over time. Older loans tend to have a less negative impact on credit scores, as they provide a longer history of successful repayments. For example, a longer credit history typically demonstrates reliability and lower risk. The percentage of individuals in this segment decreases from 10% to 8%, suggesting that fewer individuals fall within the targeted loan age range during this period, potentially due to the aging of their accounts or fewer new loans being opened.

In some embodiments, individuals actively seeking credit, defined as having 4 or more credit inquiries in the last 2 years, experience a 17-point drop in score, from 677 in 2022 to 660 in 2024. This decline reflects the detrimental impact of multiple credit inquiries, which can signal a heightened risk of financial instability or an increased reliance on credit. In some embodiments, a high number of inquiries may indicate that an individual is seeking credit from multiple sources, raising concerns about their ability to manage additional debt. Especially in recent years with high interest and inflation rate, seeking new credit may indicate higher debt burden which may be followed by financial insolvency and miss payment. The population percentage in this segment decreases slightly, from 7% to 6%, which may reflect changes in consumer behavior, such as fewer people actively seeking credit or more stringent lending practices post-pandemic.

Recent delinquency on bank card revolving accounts shows a 14-point decline, from 625 in 2022 to 611 in 2024, indicating a steady deterioration in scores for individuals with late payments or missed payments on these accounts. In some embodiments, this trend highlights the impact that delinquencies can have on an individual's credit score, as missed payments are often seen as strong indicators of credit risk. Moreover, consumers in delinquency may get further trapped with the rising interest rate and become more struggled to bring their accounts to current. Interestingly, the percentage of individuals in this segment increases from 6% to 7%, suggesting that more people are facing difficulties in managing their revolving bank card debt during this period. This increase may be due to financial challenges related to the broader economic environment, such as job losses or reduced income. Similarly, in some embodiments, recent delinquency on non-line of credit revolving accounts also shows a 14-point drop, from 625 in 2022 to 611 in 2024. The population percentage for this segment also increases from 6% to 7%, indicating a growing number of individuals facing delinquency in this category. In some cases, this trend could reflect financial struggles across a broader range of revolving credit accounts, signaling a possible decline in financial health for these individuals.

As shown herein, the higher-risk categories such as high utilization, recent installment loans, actively seeking credit, and recent delinquencies tend to experience significant drops in score. In some embodiments, these score shifts provide valuable insights into the behavior and credit risk of different subpopulations. While the overall reference baseline remains relatively stable, the more substantial shifts in these high-risk segments suggest that credit management behaviors and financial management strategies have evolved during this period. The percentage changes in these segments reflect broader shifts in consumer behavior and financial health post-pandemic, such as reduced credit-seeking behavior, improved utilization rates, or increased delinquency rates.

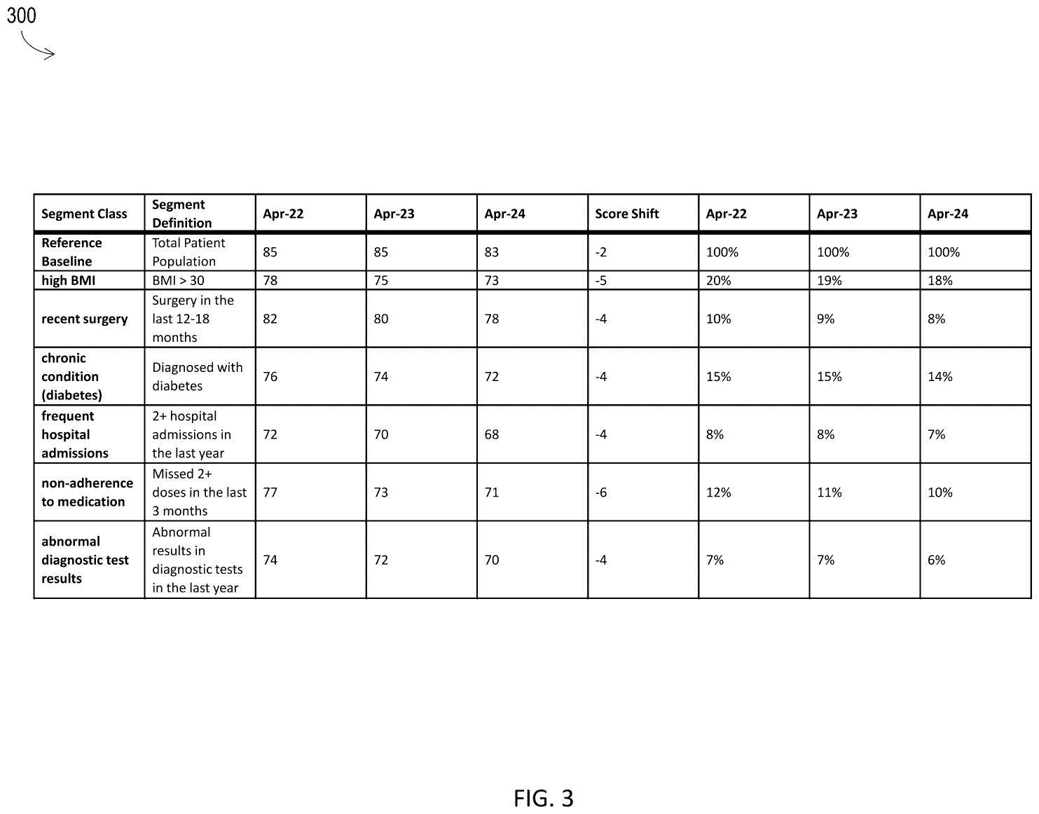

FIG. 3 is a diagram illustrating an example of the identified segments by the segment mining tool, in accordance with one or more embodiments. In this example, the considerations for searching the segment may be defined by a user, and the configurable ranges may be customizable. As shown in FIG. 3, in an example, the reference baseline health score remains relatively stable, with a minor 2-point decline from 85 in 2022 to 83 in 2024. This stability in the baseline reflects the general trend that the overall health of the population does not fluctuate significantly over time. In some cases, slight declines in the average health score could be attributed to age-related factors or broader public health trends. The reference baseline serves as a useful comparison point when analyzing shifts in specific health segments, as it reflects the overall health of the population. In some embodiments, individuals with a high BMI (Body Mass Index greater than 30) experience a 5-point decline in their health score, from 78 in 2022 to 73 in 2024. This trend reflects the gradual negative impact of high BMI on overall health, as conditions such as obesity-related diseases can affect long-term health outcomes. For example, individuals with high BMI are at an increased risk for developing cardiovascular diseases, diabetes, and other weight-related health conditions. The percentage of the population in this segment decreases from 20% to 18%, indicating that public health interventions or improved awareness around weight management may be contributing to healthier lifestyles and lower BMI levels in the population. In some embodiments, the recent surgery segment shows a 4-point decline in health score, from 82 in 2022 to 78 in 2024. This drop reflects the temporary decline in overall health after undergoing a surgical procedure. The recovery process following surgery often results in lower health scores due to the physical impact of the operation and post-operative recovery. In some cases, patients who undergo surgery face a reduction in mobility or increased medical complications during the healing process, leading to a lower health score. The population percentage in this segment decreases from 10% to 8%, likely due to successful recoveries over time, moving individuals out of this category.

In some embodiments, individuals with chronic conditions, such as diabetes, show a 4-point drop in health score over the 3-year period, decreasing from 76 in 2022 to 72 in 2024. Managing a chronic condition like diabetes can have long-term effects on health, as blood sugar regulation, medication adherence, and lifestyle changes are key factors influencing overall health. In some cases, poorly managed diabetes may lead to further complications, such as nerve damage or kidney disease, resulting in a gradual decline in health score. The percentage of the population in this segment remains relatively stable, with a slight decrease from 15% to 14%, indicating that chronic conditions continue to affect a significant portion of the population.

In some embodiments, individuals with frequent hospital admissions (2 or more admissions in the last year) experience a 4-point decline in their health score, from 72 in 2022 to 68 in 2024. This decline reflects the adverse effects that frequent hospitalizations can have on a patient's overall health. For example, repeated admissions may indicate the presence of severe or recurrent health issues, which could lead to a decline in overall well-being. In some cases, frequent hospitalizations may be related to chronic illnesses, acute medical events, or complications from treatment. The percentage of the population in this segment decreases from 8% to 7%, possibly indicating better management of health conditions that reduce the need for frequent hospital visits.

In some embodiments, individuals classified as non-adherent to medication experience a significant 6-point decline in health score, from 77 in 2022 to 71 in 2024. This segment includes individuals who have missed 2 or more doses of prescribed medication in the last 3 months. Medication non-adherence can have a severe impact on health outcomes, as failure to follow prescribed treatment regimens may result in worsening symptoms or the progression of diseases. For example, non-adherence in patients with chronic conditions such as hypertension or diabetes can lead to uncontrolled blood pressure or blood sugar levels, increasing the risk of complications. The percentage of the population in this segment decreases from 12% to 10%, possibly due to interventions or adherence programs that improve medication compliance.

In some embodiments, the abnormal diagnostic test results segment, which includes individuals who have received abnormal results in diagnostic tests within the last year, shows a 4-point decline in health score, from 74 in 2022 to 70 in 2024. Abnormal test results, such as elevated cholesterol levels, irregular heart function, or abnormal blood counts, can signal underlying health conditions that contribute to a gradual decline in overall health. For example, abnormal lab results may indicate the early stages of a disease or the presence of a condition that requires further investigation or treatment. The population percentage in this segment decreases from 7% to 6%, possibly due to improvements in patient health or successful management of abnormal conditions.

In conclusion, the shifts in health scores observed across these segments reflect broader trends in patient health outcomes. In some embodiments, the segments with higher health risks, such as non-adherence to medication, high BMI, and frequent hospital admissions, show more significant declines in health score. The gradual shifts in these segments provide valuable insights into patient behaviors and health management over time, while the overall population (represented by the reference baseline) remains relatively stable. These findings can be used to inform healthcare strategies, improve patient interventions, and monitor the effectiveness of health programs.

### Segment Profile Generation

In some embodiments, segment profiles generated by the system in the healthcare industry may provide valuable insights into patient populations by analyzing health data and identifying shifts in key metrics over time. For example, a segment profile for patients managing a chronic condition such as Type 2 Diabetes may reveal important trends in health outcomes. The mean health score for this segment might be tracked over multiple time periods, with a gradual decline observed from 76 in April 2022 to 72 in April 2024, representing a 4-point drop over two years. Similarly, the median health score may decrease from 75 to 71 during the same period, reflecting the ongoing challenges these patients face in managing their condition. This decline in health scores may be attributed to complications associated with long-term diabetes, such as cardiovascular problems or neuropathy. Additionally, the odds-to-score relationship may indicate that patients with poorly controlled blood glucose levels (as measured by high HbAlc levels) are less likely to avoid hospitalization. For example, for every 5-point increase in the health score, the likelihood of avoiding complications could increase by 10%, highlighting the importance of maintaining stable glucose levels. The segment profile may thus provide actionable insights into patient care and intervention strategies aimed at improving outcomes for individuals with diabetes.

Another example of a segment profile in the healthcare industry could involve patients recovering from major surgery. In some embodiments, the system may generate a profile for patients who underwent surgery in the last 12 months, tracking their mean health scores from 80 in April 2022 to 77 in April 2024, reflecting a 3-point decline over two years. The median health score for this population might show a similar decrease, moving from 81 to 78 over the same period. The decline in health scores may reflect the temporary reduction in overall well-being and physical ability during the post-operative recovery period. In some cases, patients may experience complications or limited mobility, contributing to this decrease in health score. The odds-to-score relationship could further demonstrate that patients with higher health scores tend to experience fewer complications and faster recovery times. For example, patients with a health score of 85 or higher might be 20% more likely to recover without further hospitalizations compared to those with lower scores. These profiles provide valuable insights into the recovery process and can help healthcare providers identify patients who may require additional support during their recovery period.

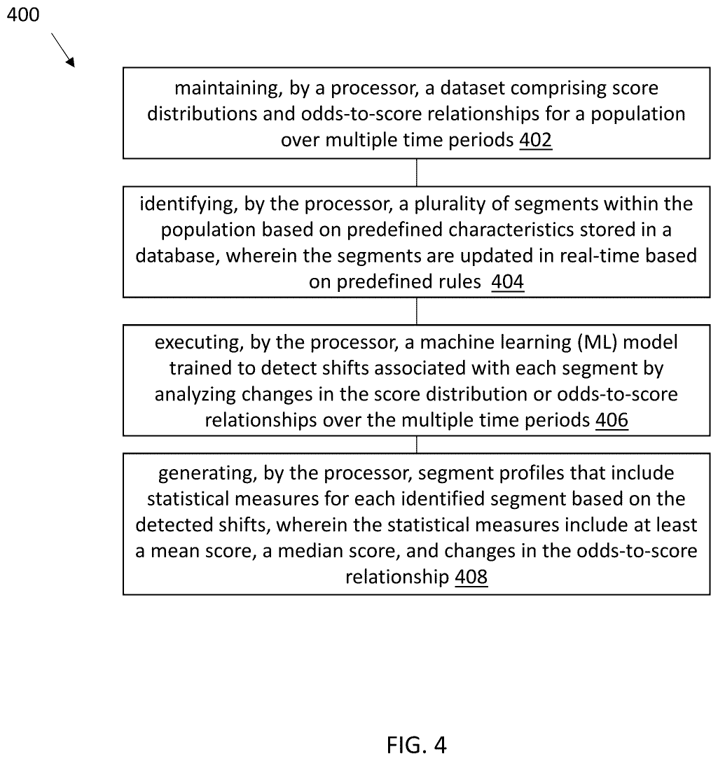

FIG. 4 is a diagram illustrating a flow chart of a process 400 for dynamic data analysis and segmentation for performance monitoring within a population, in accordance with one or more embodiments of the current subject matter. As shown in FIG. 4, the process 400 may begin with operation 402, where the system maintains, by a processor, a dataset comprising score distributions and odds-to-score relationships for a population over multiple time periods. In operation 404, the system identifies a plurality of segments within the population based on predefined characteristics stored in a database, wherein the segments are updated in real-time based on predefined rules. The process continues with operation 406, where the system executes a machine learning (ML) model trained to detect shifts associated with each segment by analyzing changes in the score distribution or odds-to-score relationships over the multiple time periods. The ML model may be trained by applying a dimension reduction technique to select relevant features and analyze shifts in score distribution and odds-to-score relationships over multiple time periods. In some embodiments, the process may include applying a threshold-based filtering process to exclude segments that do not meet minimum criteria, such as segment size, percentage of the total population, raw count of sample records, score range, and number of unique score values. In operation 408, the system generates segment profiles that include statistical measures for each identified segment based on the detected shifts, wherein the statistical measures include at least a mean score, a median score, and changes in the odds-to-score relationship. The system may also define segments using a consistent segment definition across time periods to track shifts for a set of subpopulations, with the consistent segment definition being dynamically adjusted based on predefined rules stored in a rules engine. These predefined rules can include a variety of criteria such as demographic factors (e.g., age, gender, location), behavioral patterns (e.g., purchase frequency, adherence to medication), or statistical thresholds (e.g., scoring ranges, performance metrics). The rules engine continuously monitors incoming data, comparing it against the predefined criteria to determine whether segment composition requires adjustment. The process may further involve optimizing the execution of the ML model by utilizing parallel processing across multiple processing units to enhance efficiency in high-dimensional parameter spaces. In some embodiments, the system may provide interactive visualization options on a user interface, where the visualizations include graphs and charts illustrating the shifts in score distributions, odds-to-score relationships, and other key statistics over the multiple time periods. In some embodiments, the system provides interactive visualization options on a user interface, allowing users to explore shifts in score distributions and odds-to-score relationships over multiple time periods. These visualizations may include bar charts, line graphs, heatmaps, and scatter plots, all of which may be dynamically updated based on user input or filtering criteria. Interactive features may allow users to zoom into specific time periods, compare different subpopulations, or adjust thresholds for score cutoff values, thereby enhancing data exploration and decision-making. The ML model may include a subroutine to quantify a vertical shift of an odds-to-score fitted line and changes in its slope by calculating a regression model for the odds-to-score relationship over the specified time periods.

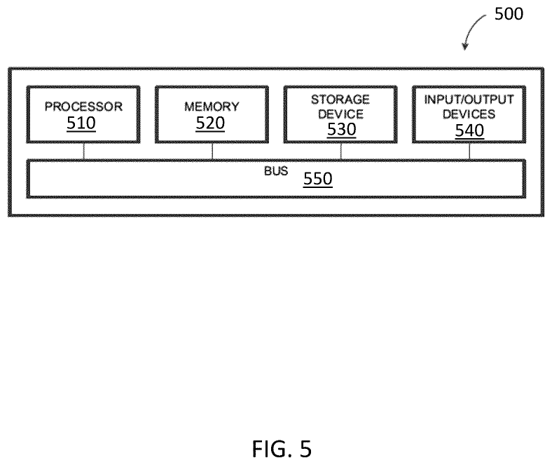

FIG. 5 depicts a block diagram illustrating a computing system 500 consistent with implementations of the current subject matter. As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The computing system 500 may additionally or alternatively include a graphic processing unit (GPU), such as for image processing, and/or an associated memory for the GPU. The GPU and/or the associated memory for the GPU may be interconnected via the system bus 550 with the processor 510, the memory 520, the storage device 530, and the input/output devices 540. The memory associated with the GPU may store one or more images described herein, and the GPU may process one or more of the images described herein. The GPU may be coupled to and/or form a part of the processor 510. The processor 510 is capable of processing instructions for execution within the computing system 500. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer-readable medium, such as volatile or non-volatile memory, that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 1000 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

### Use Case

In a healthcare setting focused on managing diabetes, a healthcare provider implements the score shift segment mining tool to enhance the effectiveness of treatment protocols by dynamically analyzing patient data over time and identifying specific segments of patients who may not be responding well to standard treatments. The tool is configured to track a variety of patient health metrics, such as blood sugar levels (HbAlc), medication adherence, diet, exercise, age, and genetic markers, which collectively determine each patient's health risk score. The process begins with the tool maintaining a dataset of score distributions and odds-to-score relationships for diabetic patients over multiple time periods, such as quarterly assessments conducted between 2020 and 2024. These scores are calculated by analyzing patient-specific health data, and the odds-to-score relationship is used to predict outcomes like the likelihood of patients achieving blood sugar control or avoiding complications.

At each time period, the tool identifies various segments within the diabetic population based on predefined characteristics, such as patients over the age of 50, those with poor medication adherence, or individuals with a specific genetic marker linked to diabetes. The tool is equipped with a machine learning (ML) model that detects shifts in score distributions and odds-to-score relationships between time periods, allowing healthcare providers to continuously monitor changes in patient responses to treatment. For example, the tool may detect that a segment of patients with a particular genetic marker is showing a consistent downward shift in their health risk scores over time, indicating that this subpopulation is not responding well to the current diabetes management protocols. In such cases, the tool would flag this segment for further review, prompting healthcare providers to investigate alternative therapeutic approaches, such as adjusting medications, introducing lifestyle interventions, or even conducting additional genetic testing.

To quantify these shifts, the tool calculates statistical measures for each identified segment, including the mean and median health scores for patients in that segment and changes in the odds-to-score relationship over time. For example, it might reveal that while the overall diabetic population has maintained stable health scores, patients with the identified genetic marker have seen a 10-point drop in their average score over a two-year period. Additionally, the odds-to-score relationship may indicate that for patients with this marker, the predicted odds of achieving blood sugar control at a given score are significantly lower than for the rest of the population. These insights enable healthcare providers to take proactive action, such as recommending new medications or adjusting the treatment plan for this segment to improve outcomes.

The tool's ability to track shifts in score distributions and odds-to-score relationships across time periods is especially valuable in identifying long-term trends that might be missed with static data analysis. For instance, a dynamic shift analysis might show that a particular segment of patients has experienced a gradual decline in health scores over several years, which may correlate with changes in the effectiveness of standard treatment protocols or the emergence of new complications. The tool can also detect cumulative shifts, such as how a patient's response to treatment changes over multiple time periods, enabling healthcare providers to determine whether their intervention strategies are effective or need to be reevaluated.

In addition to tracking score shifts, the tool can be used to monitor population proportions at specific score cutoffs, such as the proportion of patients whose health score falls below a threshold that signals a high risk of diabetes complications. For example, if the tool detects that the proportion of patients with a score below 70 (indicating poor diabetes control) has increased from 15% to 25% over the last two years, this could signal a broader issue with the current treatment protocol, prompting a review of clinical practices.

Once a shift is detected, the healthcare provider may use the insights generated by the tool to adjust their care strategies. For instance, if a segment of patients is identified as having consistently low odds of achieving blood sugar control, the provider may decide to recalibrate their treatment model by introducing targeted interventions for that segment. This could involve personalizing the treatment plan to include more aggressive medication, tailored diet and exercise regimens, or closer monitoring of adherence to prescribed therapies. By leveraging the tool's real-time analysis, the healthcare provider is able to make data-driven decisions that enhance the quality of care, improve patient outcomes, and optimize the allocation of healthcare resources.

Overall, the application of the score shift segment mining tool in this diabetes management scenario demonstrates how healthcare providers can use dynamic data analysis to not only predict outcomes but also to actively intervene when shifts in patient segments indicate that treatment protocols are no longer effective. By providing continuous, real-time insights into patient responses, the tool empowers providers to tailor their interventions based on the evolving needs of the population, ensuring that patients receive the most appropriate and effective care throughout their treatment journey.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method for dynamic data analysis and segmentation for performance monitoring within a population, the method comprising:
maintaining, by a processor, a dataset comprising score distributions and odds-to-score relationships for a population over multiple time periods;
identifying, by the processor, a plurality of segments within the population based on predefined characteristics stored in a database, wherein the segments are updated in real-time based on predefined rules;
executing, by the processor, a machine learning (ML) model trained to detect shifts associated with each segment by analyzing changes in the score distribution or the odds-to-score relationships over the multiple time periods; and
generating, by the processor, segment profiles that include statistical measures for each identified segment based on the detected shifts, wherein the statistical measures include at least a mean score, a median score, and changes in the odds-to-score relationship.

2. The method of claim 1, wherein the ML model is trained by applying a dimension reduction technique to select relevant features, and to analyze the shifts in the score distribution and the odds-to-score relationships over the multiple time periods.

3. The method of claim 1, further comprising applying, by the processor, a threshold-based filtering process to exclude segments that do not meet minimum criteria, the criteria including at least segment size, percentage of a total population, raw count of sample records, score range, and number of unique score values.

4. The method of claim 1, wherein defining the segments comprises using a consistent segment definition across time periods to determine a composition of the segment at each time and track shifts in the composition of the segment, wherein the composition of segments being dynamically adjusted based on predefined rules stored in a rule's engine.

5. The method of claim 1, wherein defining the segments comprises using a consistent population definition across time periods to identify a group of individuals at a user-specified point in time and track shifts in performance metrics for the segment across the multiple time periods.

6. The method of claim 1, further comprising optimizing, by the processor, the execution of the ML model by utilizing parallel processing across multiple processing units to enhance efficiency in high-dimensional parameter spaces.

7. The method of claim 1, wherein the ML model includes executing, by the processor, a subroutine to quantify a vertical shift of an odds-to-score fitted line and changes in its slope by calculating a regression model for the odds-to-score relationship over specified time periods.

8. A computer program product comprising a non-transient machine-readable medium storing instructions that, when executed by at least one programmable processor, cause the at least one programmable processor to perform operations comprising:
maintaining, by a processor, a dataset comprising score distributions and odds-to-score relationships for a population over multiple time periods;
identifying, by the processor, a plurality of segments within the population based on predefined characteristics stored in a database, wherein the segments are updated in real-time based on predefined rules;
executing, by the processor, a machine learning (ML) model trained to detect shifts associated with each segment by analyzing changes in the score distribution or odds-to-score relationships over the multiple time periods; and
generating, by the processor, segment profiles that include statistical measures for each identified segment based on the detected shifts, wherein the statistical measures include at least a mean score, a median score, and changes in the odds-to-score relationship.

9. The computer program product of claim 8, wherein the ML model is trained by applying a dimension reduction technique to select relevant features, and to analyze shifts in the score distribution and the odds-to-score relationships over the multiple time periods.

10. The computer program product of claim 8, wherein the operations further comprise applying, by the processor, a threshold-based filtering process to exclude segments that do not meet minimum criteria, the criteria including at least segment size, percentage of a total population, raw count of sample records, score range, and number of unique score values.

11. The computer program product of claim 8, wherein defining the segments comprises using a consistent segment definition across time periods to determine a composition of the segment at each time and track shifts in the composition of the segment, wherein the composition of segments being dynamically adjusted based on predefined rules stored in a rule's engine.

12. The computer program product of claim 8, wherein defining the segments comprises using a consistent population definition across time periods to identify a group of individuals at a user-specified point in time and track shifts in performance metrics for the segment across multiple time periods.

13. The computer program product of claim 8, further comprising optimizing, by the processor, the execution of the ML model by utilizing parallel processing across multiple processing units to enhance efficiency in high-dimensional parameter spaces.

14. The computer program product of claim 8, wherein the ML model includes executing, by the processor, a subroutine to quantify a vertical shift of an odds-to-score fitted line and changes in its slope by calculating a regression model for the odds-to-score relationship over specified time periods.

15. A system comprising:
a programmable processor; and
a non-transient machine-readable medium storing instructions that, when executed by the processor, cause the programmable processor to perform operations comprising:
maintaining, by a processor, a dataset comprising score distributions and odds-to-score relationships for a population over multiple time periods;
identifying, by the processor, a plurality of segments within the population based on predefined characteristics stored in a database, wherein the segments are updated in real-time based on predefined rules;
executing, by the processor, a machine learning (ML) model trained to detect shifts associated with each segment by analyzing changes in the score distribution or odds-to-score relationships over the multiple time periods; and
generating, by the processor, segment profiles that include statistical measures for each identified segment based on the detected shifts, wherein the statistical measures include at least a mean score, a median score, and changes in the odds-to-score relationship.

16. The system of claim 15, wherein the ML model is trained by applying a dimension reduction technique to select relevant features, and to analyze shifts in score distribution and odds-to-score relationships over multiple time periods.

17. The system of claim 15, wherein the operations further comprise applying, by the processor, a threshold-based filtering process to exclude segments that do not meet minimum criteria, the criteria including at least segment size, percentage of a total population, raw count of sample records, score range, and number of unique score values.

18. The system of claim 15, wherein defining the segments comprises using a consistent segment definition across time periods to determine a composition of the segment at each time and track shifts in the composition of the segment, wherein the composition of segments being dynamically adjusted based on predefined rules stored in a rule's engine.

19. The system of claim 15, wherein defining the segments comprises using a consistent population definition across time periods to identify a group of individuals at a user-specified point in time and track shifts in performance metrics for the segment across multiple time periods.

20. The system of claim 15, further comprising optimizing, by the processor, the execution of the ML model by utilizing parallel processing across multiple processing units to enhance efficiency in high-dimensional parameter spaces.
